(19) United States
(12) Patent Application Publication
(10) Pub. No.: US 2022/0264709 A1
(43) Pub. Date: Aug. 18, 2022

(54) ADAPTIVE COOKING DEVICE

(71) Applicant: X Development LLC, Mountain View, CA (US)

(72) Inventors: Alexander Martin Zoellner, Los Gatos, CA (US); Claudia Truesdell, Palo Alto, CA (US); Cyrus Behroozi, Menlo Park, CA (US); Shane Washburn, Oakland, CA (US); Jeffrey Bush, Los Altos, CA (US); Thomas Peter Hunt, Oakland, CA (US); Peter Christian Norgaard, Mountain View, CA (US)

(21) Appl. No.: 17/675,233

(22) Filed: Feb. 18, 2022

Related U.S. Application Data
(60) Provisional application No. 63/150,784, filed on Feb. 18, 2021.

(51) Int. Cl. H05B 6/64; H05B 6/68; H05B 6/72; A23L 5/10; A47J 36/32

(52) U.S. Cl. CPC H05B 6/6447; H05B 6/686; H05B 6/72; A23L 5/15; A23V 2002/00; H05B 6/6455; H05B 6/6458; H05B 6/6464; A47J 36/32

(57) ABSTRACT

According to a first aspect, there is provided an adaptive cooking device that includes: a cooking chamber configured to receive a food product, an antenna assembly, an RF power source, a sensor assembly coupled to the cooking chamber and comprising a plurality of sensors, each sensor configured to obtain a measurement characterizing a cooking process in real-time, and one or more sensors of the plurality of sensors configured to obtain a different type of the measurement, and a controller coupled to the antenna assembly, the sensor assembly, and the RF power source, wherein the controller is configured to: receive the measurement characterizing the cooking process from the sensor assembly, process the measurement to determine a modified cooking process, and operate the antenna assembly and the RF power source in accordance with the modified cooking process in real-time.

### CROSS REFERNCE TO RELATED APPLICATION

This application claims the benefit of U.S. Provisional Application No. 63/150,784, filed Feb. 18, 2021, the contents of which are incorporated by reference herein.

### TECHNICAL FIELD

This specification relates generally to cooking devices, and more particularly to cooking devices and heating systems that can be used to generate a pattern of heat distribution in a load.

### BACKGROUND

Conventional cooking devices, such as microwave ovens, include a cavity for receiving a load to be heated. Generally, electromagnetic energy is absorbed by the food depending on the frequency implemented and the dielectric properties of the food. Microwave ovens rely on a magnetron to generate high power RF (Radio Frequency) electromagnetic energy that interacts with the microwave cavity to create patterns of standing waves and transfer energy to the load. The magnetron is an uncontrolled oscillator without feedback mechanisms to monitor or set the frequency.

Although conventional microwave ovens deliver rapid heating to the food, the distribution of heat tends to be highly non-uniform with cold and hot spots, resulting in food with overcooked dehydrated parts, and cold or raw parts. Power delivery tends to be highly variable as the system heats up. As a consequence, microwave ovens heat consequent loads to variable efficiency. Further, due to the open-loop nature of the magnetron-based microwave systems, conventional ovens are only able to deliver an approximate energy output that decreases over time, as they cannot adapt to irradiated energy and energy reflected from the food into the cavity as the food is heated. Further, conventional microwave ovens are unable to adjust parameters such as phase, frequency, and output power, which leads to large swings in efficiency when the load volume, distribution, and number of food items change. Further, conventional microwaves create standing waves inside a cavity that provide too much energy to the food in hot spots and too little in cold spots. Conventional microwave designs aim to create a more homogenous heating by rotating the food inside the cavity or by stirring the electromagnetic field by means of a metal fan. Overall, conventional microwave ovens suffer from poor heating process control.

### SUMMARY

This specification describes a cooking device with dynamically configurable geometry and heating systems that can adapt to different food types and cooking methods.

According to a first aspect, there is provided an adaptive cooking device, including: a cooking chamber configured to receive a food product, an antenna assembly comprising a plurality of antennas, each antenna of the plurality of antennas coupled to an RF (Radio Frequency) power source and configured to deliver an RF power to the food product, a sensor assembly coupled to the cooking chamber and comprising a plurality of sensors, each sensor configured to obtain a measurement characterizing a cooking process in real-time, and one or more sensors of the plurality of sensors configured to obtain a different type of the measurement, and a controller coupled to the antenna assembly, the sensor assembly, and the RF power source, wherein the controller is configured to: i) receive the measurement characterizing the cooking process from each of the sensors, ii) process the measurement to determine a modified cooking process, and iii) operate the antenna assembly and the RF power source in accordance with the modified cooking process in real-time.

In some implementations, the controller is configured to periodically receive the measurement characterizing the cooking process from each of the sensors.

In some implementations, the controller is further configured to activate or deactivate one or more sensors of the plurality of sensors in response to determining the modified cooking process.

In some implementations, the controller is configured to process the measurement to determine the modified cooking process using a trained machine learning model.

In some implementations, the machine learning model has been trained using supervised learning techniques.

In some implementations, the trained machine learning model is configured to determine correlations between the measurements.

In some implementations, the plurality of sensors include one or more of: a visible imaging camera, and infrared imaging camera, a spectral imaging camera, a mass sensor, a humidity sensor, a sound sensor, a motion sensor, an RF sensor, a rheology sensor, a thermocouple, a sound transducer, a gas sensor, a conductivity sensor, a light sensor, a pulse oximeter, an air pressure sensor and an ozone sensor.

In some implementations, the controller is further configured to: i) receive external data characterizing the food product, and ii) process the measurement and the external data characterizing the food product to determine the modified cooking process.

In some implementations, the controller is configured to operate the antenna assembly in accordance with the modified cooking process by adjusting one or more of: a frequency, a phase, and the RF power, of each of the plurality of antennas in real-time.

In some implementations, the measurement characterizing the cooking process in real time comprises one or both of a state of the cooking chamber and a state of the food product.

In some implementations, the adaptive cooking device further includes a movable deflector configured to support the food product, and wherein the controller is coupled to the movable deflector and configured to operate the antenna assembly and the movable deflector in accordance with the modified cooking process in real-time.

According to a second aspect, there is provided a method for preparing a food product using an adaptive cooking device that includes: (i) a cooking chamber, (ii) an antenna assembly comprising a plurality of antennas, (iii) a sensor assembly comprising a plurality of sensors, wherein one or more sensors of the plurality of sensors are configured to obtain a different type of a measurement that characterizes a cooking process, (iv) an RF power source, and (v) a controller, the method comprising: operating, by the controller, the antenna assembly and the RF power source, to deliver an RF power to the food product disposed in the cooking chamber according to an initial cooking process, obtaining, in real-time and by the plurality of sensors, the measurement that characterizes the initial cooking process, receiving, by the controller, the measurement that characterizes the initial cooking process, processing, by the controller, the measurement to determine a modified cooking process, and operating, by the controller, the antenna assembly and the RF power source according to the modified cooking process.

In some implementations, the method further includes receiving, by the controller, external data characterizing the food product, and determining, by the controller, the initial cooking process based on the external data.

According to a third aspect, there are provided one or more non-transitory computer-readable storage medium coupled to one or more processors that, when executed by the one or more processors, cause the one or more processors to perform the operations of any preceding aspect.

Particular embodiments of the subject matter described in this specification can be implemented so as to realize one or more of the following advantages.

The cooking device described in this specification harnesses recent advances in solid-state RF technology, optimizes efficiency and power of energy transfer to eliminate cold and hot spots, significantly enhances control of energy delivery, and intelligently adapts to the particular cooking requirements of different types of food in real-time.

The cooking device of the present disclosure employs one or more RF solid-state amplifiers, which makes it benefit from much of the recent advancements in communication technology, such as 5G (i.e., fifth generation technology standard for broadband cellular networks). The cooking device described in this specification is able to provide consistent performance during the varied load conditions required for cooking and optimize the cooking process. In contrast to conventional microwave ovens, the solid state RF amplifier output can be modulated such that the variation of power and gain with temperature is corrected with a closed-loop power control system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example adaptive cooking device.

FIG. 2 illustrates an example adaptive cooking device in more detail.

FIG. 3 is a flow diagram of an example process for preparing a food product using an adaptive cooking device.

FIG. 4 illustrates example heat distributions generated by an adaptive cooking device.

Like reference numbers and designations in the various drawings indicate like elements.

### DETAILED DESCRIPTION

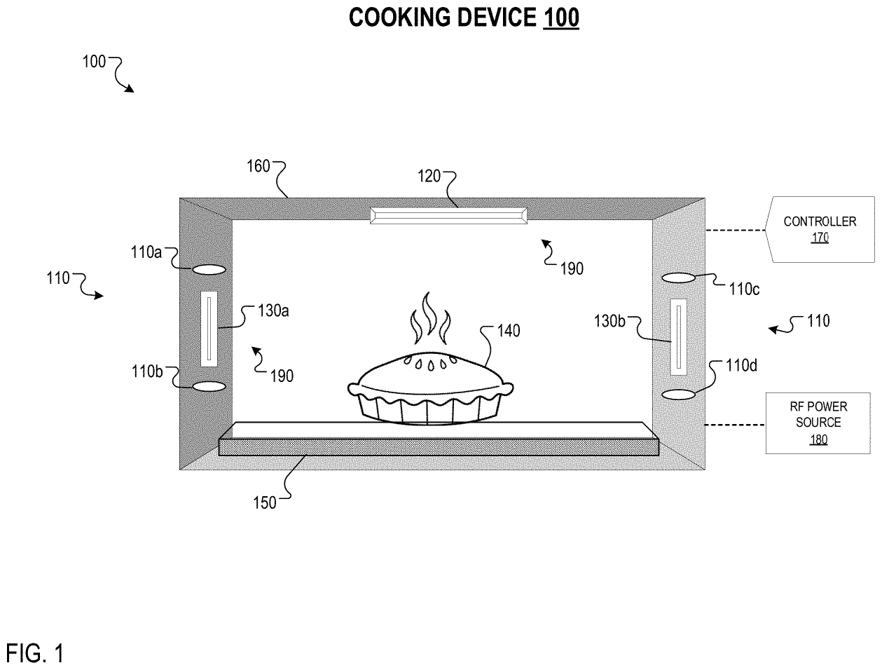

FIG. 1 illustrates an example adaptive cooking device 100. The cooking device 100 can be, e.g., an appliance that can be used to prepare, heat, or otherwise cook, a food product 140. The food product 140 can generally include any type of food, e.g. pie, soup, poultry, bread, vegetables, or any other appropriate type of food. In some implementations, the cooking device 100 can be used for other purposes outside of cooking, such as, e.g., evaporating or steaming fluids, disinfecting objects, heating objects or fluids, or any other appropriate purpose.

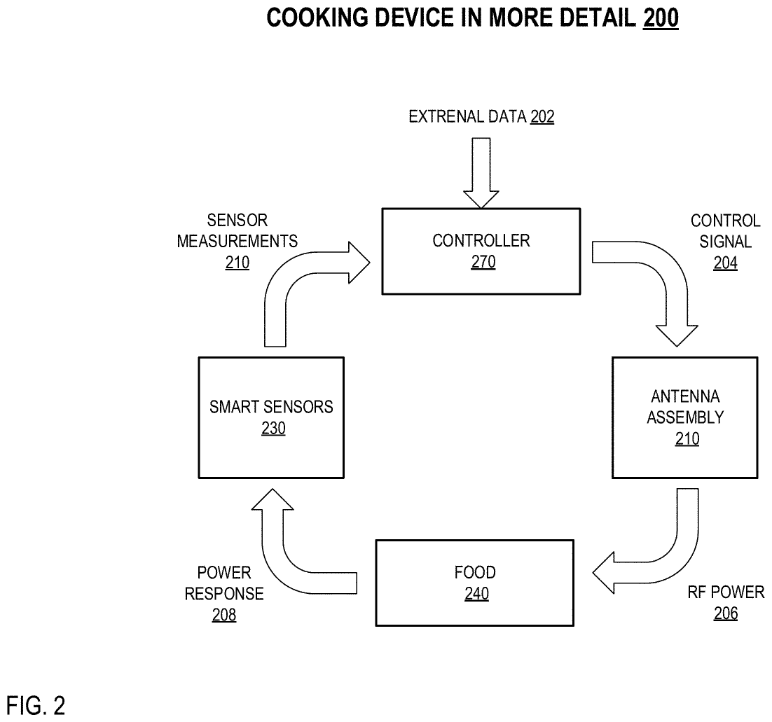

The coking device 100 can be configured to operate in a closed feedback loop. This process will be described in more detail below with reference to FIG. 2. The cooking device 100 can include a cooking chamber 160 (e.g., a cavity) that can be configured to receive the food product 140. In some implementations, the chamber 160 can include a food product placement area 150, e.g., a deflector. The chamber 160 is illustrated as being open in FIG. 1 for ease of reference. Generally, the chamber 160 can be enclosed and can include means for placing the food product 140 inside, e.g., a door. The chamber 160 can be made of any appropriate material. In some implementations, the chamber 160 can be configured to reflect, or contain, an energy inside the chamber 160. The cooking device 100 can further include an antenna assembly 110 that can include multiple antennas 110a, 110b, 110c, 110d.

The antenna assembly 110 can include any number of antennas, e.g., two, four, five, ten, or twenty antennas, arranged in any appropriate configuration inside the chamber 160. In some implementations, the number of antennas can be configured according to a desired level of power generation and delivery. The antenna assembly 110 (e.g., each antenna 110a, 110b, 110c, 110d) can be coupled to a Radio Frequency (RF) power source 180, e.g., a solid-state RF power amplifier and 5G solid-state microchip. The digital RF power source 180 can be configured to accurately control frequency, amplitude, and phase of the RF waves and to detect reflections from within the cooking chamber 160. In some implementations, the cooking device can further include other power sources in any appropriate combination, e.g., lasers, convection heat, humidity, steam, impingement air (e.g., convection at high speed), hot plates, or any other appropriate power sources.

The RF power source 180 and the antenna assembly 110 can be configured to deliver RF power to the food product 140 inside the chamber 160 in any appropriate manner. In one example, the antenna assembly 110 can include a coupler and each antenna can include a switch that, when activated, configures the antenna to deliver the RF power to the food product 140 inside the chamber 160. A single antenna can excite a single frequency mode (e.g., a single waveform) inside the chamber 160, or multiple frequency modes (e.g., multiple waveforms), inside the chamber 160. The RF power source 180 can include a switch, or multiple switches for each antenna, that can be activated, or deactivated, by a controller 170, e.g., individually.

In some implementations, the controller 170 can be configured to operate the antennas and the RF power source 180 such that some, or all, antennas in the assembly 110 deliver a different frequency, phase, and/or output RF power to the chamber 160. For example, the controller 170 can superimpose different RF frequency modes inside the cooking chamber 160 so as to generate a uniform heat distribution in the food product 140 such that, e.g., more energy is delivered to regions of the food product 140 that are colder, and less energy is delivered to the regions of the food product 140 that are hotter.

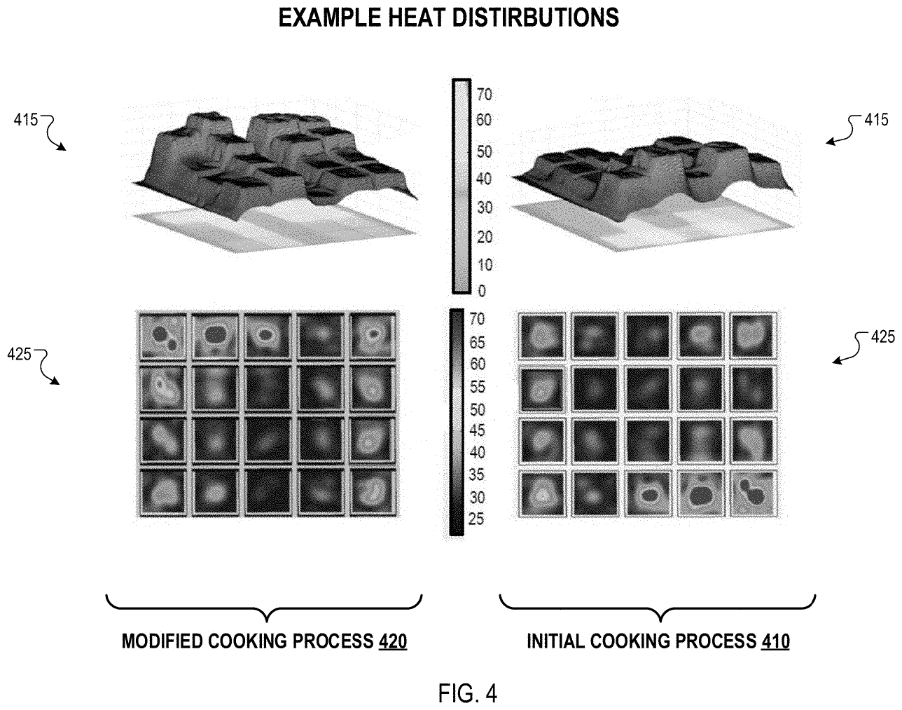

In other words, the cooking device 100 can excite a particular frequency mode, or multiple frequency modes, inside the cooking chamber 160, which can generate a specific pattern of the electromagnetic wave distribution, e.g., a specific distribution of heat inside the chamber 160 and/or the food product 140. By exciting and superimposing different frequency modes inside the chamber, the cooking device 100 can optimize heating distribution, and penetration depth, for a particular food. Example heat distribution that can be generated by the cooking device 100 will be described in more detail below with reference to FIG. 4.

In some implementations, the cooking device 100 can superimpose, e.g., mix, different ISM (Industrial, Scientific and Medical) RF bands that are reserved for industrial, scientific, and medical applications. These frequency bands can be, e.g., as high as 24.125 GHz and as low as 13.56 MHz. Other frequencies are also possible. The cooking device 100 can also be implemented with a single ISM band. The cooking device 100 can additionally include any other appropriate electronic devices that can be configured to deliver the RF power inside the chamber 160 and the food product 140, e.g., transmitters, amplifiers, or any other appropriate components.

The cooking device can further include a sensor assembly 190 that can include multiple smart sensors 120, 130a, and 130b. The sensor assembly 190 can be configured to measure and monitor the state of the food product 140 and/or the state of the cooking chamber 160 in real-time. The sensors can be arranged in any appropriate configuration inside the cooking chamber 160. In one example, some of the sensors can be arranged on the walls of the cooking chamber 160 and some of the sensors can be coupled to the food product 140. Each of the sensors can be further coupled to the controller 170. As will be described in more detail below, the controller 170 can be configured to receive the sensors measurements, analyze them, and intelligently modify the cooking process in real-time so as to optimize the quality of the cooked food product 140, e.g., by modifying any appropriate aspect of the cooking process, e.g., cooking time, frequency modes inside the chamber 160, output RF power, or any other appropriate aspect of the cooking process. In some implementations, sensors 190 can obtain the measurement periodically, e.g., at a time interval of, e.g., every 1 second, 10 seconds, 1 minute, 5 minutes, or any other appropriate time interval.

In particular, each of the sensors can be configured to obtain a measurement characterizing a cooking process in real-time, and one or more sensors can be configured to obtain a different type of measurement from the measurement obtained by the other sensors. For example, sensors 130a and 130b can be configured to obtain one type of measurement, while sensor 120 can be configured to obtain a different type of measurement. While only three smart sensors are shown in FIG. 1, the cooking device can include any appropriate number of sensors, e.g., two, three, five, ten, or fifty.

Generally a “measurement characterizing a cooking process” can refer to any measurement that conveys information about the state of the cooking chamber 160 and/or the state of the food product 140 before, during, or after RF power is applied to the food product 140 inside the chamber 160. In one example, the measurement can be, e.g., a temperature inside the chamber 160, or of the food product 140. In another example, the measurement can characterize global or local properties of the food product 140, e.g., the type and composition of the food and the state of food. Different types of sensors and sensor measurements are described in more detail next.

In some implementations, the sensors can include a vision camera, a video camera, a thermal camera, or any other appropriate camera configured to capture image and/or video data. The camera can be positioned inside the chamber 160 such that a field of vision of the camera is inside the chamber 160. In one example, a thermal imaging camera can obtain image data that represents a surface temperature of the food product 140, e.g., as a color-coded temperature map. The vision camera can, e.g., obtain image data that visually represents the food product 140, e.g., a geometry of the food product inside the cooking chamber 160. The controller 170 can receive these measurements from the sensors and process them to, e.g., identify regions of the food product 140 that are colder than the other regions of the food product 140, recognize tar weight of the food product 140 inside the chamber 160, generate data that can be used to perform dosage calibration, or detect bubbles in the food product 140.

The sensors can further include other types of sensors that can obtain data that characterizes whether the food product 140 is cooked to a desired level (e.g., determine “doneness” of the food). For example, a humidity sensor can measure the overall humidity of the food product 140 (e.g., moisture content). The measure of humidity can characterize phase changes of the food product 140 (e.g., to determine whether a cake is cooked). The controller 170 can process data received from the humidity sensor to generate a three-dimensional map that can allow locating areas in the food product 140 that are generating steam. In some implementations, the humidity sensor can measure humidity as a function of time. The cooking device can process these measurements to intelligently determine and predict the doneness of the food product 140.

As another example, the sensors can further include an array of microphones that can obtain directional sound measurements, and an accelerometer that can measure motion or oscillation in the food product 140. In another example, an RF sensor can obtain a measurement of the RF energy absorption in the food product 140. In yet another example, an array of thermocouples can measure a temperature of the food product 140. The controller 170 can receive the measurements and process them to determine the protein state of the food product 140, e.g., whether the meat in the food product 140 is cooked through. In some implementations, the controller 170 can process the measurements to correlate food safety minimum temperature with RF measurements to ensure that the food is cooked to a desired state. The measurements from thermocouples, e.g., coupled to the walls of the cooking chamber 160, can also be processed by the controller 170 to confirm the frequency mode inside the chamber 160 by, e.g., measuring spatial heating of the chamber walls.

In yet another example, the sensors can include rheology sensors that can obtain measurements characterizing rheological properties of the food product 140. For example, the controller 170 can process a time-series of rheological measurements and determine whether the food has reached a desired level of doneness.

The sensors can further include sound transducers that can obtain measurements characterizing a speed of sound in the chamber 160. In one example, the transducers can be positioned on opposite sides of the chamber 160. Since the speed of sound in air changes with temperature and humidity, the transducers can obtain measurements that characterize, e.g., the state of the food product 140 as it is being cooked in real time. Similarly, ultrasound measurements can indicate food product 140 composition. For example, ultrasound transducers can be placed under the food product 140 and can measure its internal, mechanical, and acoustic properties. The controller 170 can process these measurements to determine whether the food product 140 is frozen, and the protein state of the food product 140.

In yet another example, the sensors can measure the amount of RF (e.g., identify a particular frequency mode) in an empty chamber and the controller 170 can be configured to correlate this measurement with the amount of RF in the chamber measured by the RF sensor when the food product is placed inside the chamber 160. For example, the RF sensor can be configured to obtain a time-series of RF measurements and, based on these measurements, the controller 170 can track frequency mode changes inside the chamber 160 as the food is being cooked. In other words, the controller 170 can be configured to determine how the properties of the food product 140 are changing with time, e.g., compare the frequency modes (or their overlap) for when the food product 140 is frozen with the modes when the food product 140 is defrosted. Moreover, the RF sensor can obtain a measurement that characterizes how much RF power is reflected back from the chamber 160, and the controller 170 can adaptively manage this amount by dynamically adjusting the RF power output delivered through the antenna assembly 110.

In yet another example, the sensors can include gas and smoke sensors for detecting VOCs (Volatile Organic Compounds), aerosols and smoke. Sensors can further include: a scale for measuring weight (e.g., food product quantity) inside the chamber, conductivity sensors for measuring the food composition and wetness, a hardness (e.g., density) sensor for measuring food composition and state, a light sensor for measuring light transmission in the food, a pulse oximeter, spectral camera, air pressure sensor, ozone sensor, and a sensor for measuring laser absorption, transmission and reflection at specific wavelengths. In yet another example, the sensors can further include a sensor array and an array of fans that can pull the air through the chamber 160 such that the sensor array can pick up scents inside the chamber. The array of fans can also be implemented to measure humidity levels inside the chamber by measuring the air flow through the chamber. Although various sensors are described above, the sensor assembly 190 can include any other appropriate types of sensors arranged in any appropriate configuration inside the chamber 160.

As described above, the controller 170 can be coupled to the antenna assembly 110, the sensor assembly 190, and the RF power source 180. In some implementations, the controller 170 can be implemented as computer programs on one or more computers located in one or more locations that are configured to receive the measurements characterizing the cooking process from the sensor assembly 190 (e.g., receive a measurement from each of the sensors 130a, 130b, and 120 included in the sensor assembly 190) and process the measurements to determine a modified cooking process. A “modified cooking process” can generally refer to a cooking process that has been adjusted in response to the measurements obtained by the sensors. Modifying the cooking process can include, e.g., adjusting the length of time over which the RF power is applied to the chamber 160 and the food product 140, adjusting the RF power output, frequency, and/or phase delivered by each of the antennas in the antenna assembly 110, activating, or deactivating, one or more sensors in the sensor assembly 190, or any other appropriate parameter of the cooking process.

In order to modify the cooking process, the controller 170 can process the measurements obtained by sensors 190 in any variety of ways. In some implementations, the controller 170 can be configured according to artificial intelligence and machine learning models. For example, the controller 170 can include a neural network that can be configured to process the sensor measurements to perform any variety of machine learning tasks. In one example, the machine learning task can be, e.g., to process the measurements and generate an output that classifies the measurements into a predefined number of possible categories. Generally, the neural network can be configured to process any appropriate type of data, e.g., image data, video data, audio data, odor data, point cloud data, magnetic field data, electric field data, and any other appropriate data or a combination thereof.

As a particular example, the neural network input can be an image of the food product 140 obtained using one or more of the sensors 190 (e.g., a vision camera, an infrared camera, or any other type of sensor), each category can specify a type of food product 140 (e.g., bread, protein, eggs, etc.) or any other appropriate aspect of the food product 140 (e.g., a temperature), and the neural network can classify the image into a category if the image depicts the food product (or a temperature) included in the category. In some implementations, the neural network can process the image data (e.g., obtained using the infrared camera) and classify each pixel in the image according to its color and corresponding temperature of the food product 140 included in that pixel in the image. After classifying each pixel, the controller 170 can determine, e.g., the heat distribution, or a distribution of any other appropriate physical property inside the chamber 160 and/or the food product 140.

In another example, the neural network can process odor data (e.g., obtained by the scent sensors inside the chamber 170), each category can specify a type of odor, and the neural network can classify the odor into a category if the odor is of the type specified by the category. For example, the neural network can process odor data to generate a respective score for each of multiple possible odor categories, e.g., “sweet,” “putrid,” or “musky.” The score for an odor category can define a likelihood that the odor data is included in the odor category. Based on these scores, the controller 170 can determine, e.g., the doneness of the food product 140, or any other appropriate aspect of the food product 140, and accordingly modify the cooking process.

In yet another example, the neural network can process other types of data (e.g., a physical property such as pressure, RF power, magnetic field, or any other appropriate property, measured by the sensors 190 at different spatial locations inside the chamber 160) to generate an output characterizing the data, e.g., a two-dimensional or three-dimensional map, or a point cloud, representing a particular spatial region inside the chamber 160, and/or the surface or the geometry of the food product 140. For example, the neural network can generate an output that infers a two-dimensional or three-dimensional distribution (e.g., a continuous distribution) of the physical property inside the chamber 160.

In some implementations, the controller 170 can determine correlations between the measurements obtained by the sensors 190. For example, the controller 170 can superimpose a two-dimensional map, or three-dimensional map, of a particular physical property (e.g., temperature) with other types of measurements obtained by the sensors (e.g., RF power, frequency mode, or multiple frequency modes, pressure, conductivity, etc.) at different spatial locations inside the chamber 160. Based on these correlations, the controller 170 can intelligently modify the cooking process, e.g., modify RF power output supplied by each of the antennas in the antenna assembly 110 such that regions of the food product 140 that are colder receive more RF power, and regions of the food product 140 that are hotter receive less RF power.

In some implementations, the controller 170 can receive external data and process the external data together with the measurements obtained by the sensors 190 in order to determine the modified cooking process. The external data can include any appropriate information relating to the cooking process, e.g., a recipe, a type of food, food composition, a desired level of cooking (e.g., medium-rare or well-done), food safety information, or any other appropriate aspect of the cooking process. The controller 170 can process the information and modify the cooking process in a similar way as described above, e.g., by modifying the time over which RF power is supplied to the food product, modifying the RF power output of each of the antennas, modifying the superposition of frequency modes, or in any other appropriate manner. As a particular example, the external information can specify an internal temperature of the food product 140 at which it is considered to be done and safe to consume, and the controller 170 can use this information to modify the cooking process accordingly.

The neural network can be trained in any appropriate manner. In one example, the neural network can be trained using supervised learning techniques on a set of training data. The training data can include a set of training examples, where each training example specifies: (i) an image of the food product 140 and/or the chamber 160, and (ii) a target prediction corresponding to the image. The training data can include multiple sets of training examples, and each set can correspond to a particular aspect of the cooking process and/or a different type of the food product 140. For example, a first set of training examples can include different images of meat at various stages of the cooking process, e.g., from uncooked to fully cooked.

A training engine can train the neural network by sampling a batch (i.e., set) of training examples from the training data, and processing the respective image included in each training example using the neural network to generate a corresponding prediction. The training engine can determine gradients of an objective function with respect to the parameters of the neural network, where the objective function measures an error between: (i) the predictions generated by the neural network, and (ii) the target predictions specified by the training examples. The training engine can use the gradients of the objective function to update the values of the parameters of the neural network, e.g., to reduce the error measured by the objective function. The error can be, e.g., a cross-entropy error, a squared-error, or any other appropriate error. The training engine can determine the gradients of the objective function with respect to the parameters, e.g., using backpropagation techniques. The training engine can use the gradients to update the neural network parameters using the update rule of a gradient descent optimization algorithm, e.g., Adam, RMSprop, or any other appropriate algorithm.

After training, the controller 170 can process the measurements obtained by the sensors 190 and determine the modified cooking process in a similar way as described above. After determining the modified cooking process, the controller 170 can operate the antenna assembly 110 and the RF power source 180 in accordance with the modified cooking process. As a particular example, sensors 190 can be configured to periodically obtain measurements characterizing the cooking process at each of multiple time steps. At each time step, the controller 170 can process the measurements and, optionally, external data, and determine the modified cooking process. Then, at each time step, the controller can accordingly operate the RF power source 180 and the antenna assembly 110.

In this manner, the cooking device 100 can dynamically adjust the cooking process in real-time and in response to the measurements obtained by multiple smart sensors 190 disposed in the cooking chamber 160 that can indicate, e.g., continuously changing state of the food product 140 as it is being cooked. Accordingly, the cooking device 100 is able to intelligently modify the cooking process in real-time so as to ensure high quality of the prepared food product 140 and to ensure uniformity and consistency across multiple loads and preparation cycles.

The cooking device 100 is described in more detail below.

FIG. 2 illustrates an example adaptive cooking device 200 (e.g., the cooking device 100 in FIG. 1) in more detail. The cooking device 200 can be configured to prepare a food product 240, and can include: (i) a controller 270, (ii) an antenna assembly 210, (iii) smart sensors 230, and an RF power source (not shown).

The coking device can be configured as a closed-feedback system. For example, as described above with reference to FIG. 1, in some implementations, the controller 270 can receive external data 202, e.g., a recipe, and determine an initial cooking process. The controller 270 can provide a control signal 204 to the antenna assembly 210 in accordance with the initial cooking process. The antenna assembly 210 can deliver corresponding RF power 206 to the food product 240. As the food product 240 is being cooked, it can generate the RF power response 208 that can be characterized by the change in the state of the food product 240. This power response can be detected by the smart sensors 230 that can obtain the sensor measurements 210 and provide these measurements to the controller 270.

The controller 270 can process the sensor measurements 210 and determine the modified cooking process. Then, the controller 270 can send a new control signal to the antenna assembly in accordance with the modified cooking process. In this way, the cooking device 200 can periodically obtain sensor measurements that indicate the progress of the cooking process, and intelligently modify the cooking process in real-time.

Example process for preparing the food product using the adaptive cooking device 200 is described in more detail next.

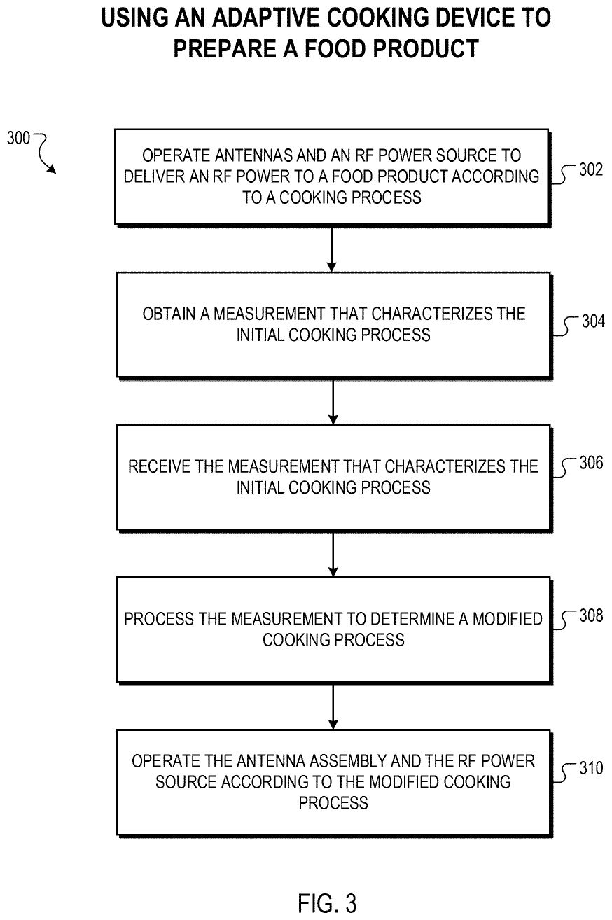

FIG. 3 is a flow diagram of an example process 300 for preparing a food product using an adaptive cooking device. In some implementations, the process 300 can be performed by the adaptive cooking device that includes: (i) a cooking chamber, (ii) an antenna assembly including multiple antennas, (iii) a sensor assembly 190 including multiple sensors, where one or more of the sensors are configured to obtain a different type of a measurement that characterizes a cooking process, (iv) an RF power source, and (v) a controller. For example, the process 300 can be performed by the adaptive cooking device 100 in FIG. 1, or the adaptive cooking device 200 in FIG. 2. In some implementations, the example process 300 can be performed by a system that includes one or more computer-executable programs executed using one or more computing devices.

The system operates, by the controller, the antenna assembly and the RF power source, to deliver an RF power to the food product disposed in the cooking chamber according to an initial cooking process (302). In some implementations, the system can receive external data characterizing the food product, e.g., a type of the food product, a recipe, or any other appropriate data, and determine the cooking process based on the data. For example, the system can determine an initial RF output, phase, and/or frequency mode, to be delivered to the food product through each of the antennas in the antenna assembly, based on the food product type. As another example, the system can determine an initial cooking time based on, e.g., the recipe, and/or the food type.

The system obtains, in real-time and by multiple sensors, the measurement that characterizes the cooking process (304). As described above with reference to FIG. 1, the system can include the sensor assembly having multiple sensors, where each sensor is configured to obtain the measurement characterizing the cooking process in real-time. One or more of the sensors in the assembly can be configured to obtain a different type of measurement from the other sensors in the assembly. For example, the sensor assembly can include a vision camera, a humidity sensor, and one or more RF sensors.

The system receives, by the controller, the measurement that characterizes the cooking process (306).

The system processes, by the controller, the measurement to determine a modified cooking process (308). As described above with reference to FIG. 1, in some implementations, the system can include, e.g., a trained machine learning model that is configured to process the measurements and generate an output that is a prediction characterizing the cooking process.

The system operates, by the controller, the antenna assembly and the RF power source according to the modified cooking process (310). For example, the system can adjust RF power output, frequency mode, and/or phase of RF power delivered by the antennas to the food product.

Example heat distribution that can be generated by the adaptive cooking device is described in more detail next.

FIG. 4 illustrates example heat distributions generated by an adaptive cooking device (e.g., the device 100 in FIG. 1, or the device 200 in FIG. 2). As described above, the adaptive cooking device can include an antenna assembly and an RF power source coupled to a controller. The controller can operate the antenna assembly and the RF power source according to an initial cooking process 410. The initial cooking process can specify, e.g., RF power output, frequency, and phase, of RF power delivered by each antenna in the antenna assembly to a food product in a cooking chamber of the cooking device.

In some implementations, the antenna assembly can generate a superposition of different frequency modes inside the chamber. The superposition can generate a particular pattern of heat distribution 425 inside the chamber. For example, the RF power output 415 (e.g., indicated by the protrusions in FIG. 4) can be higher in different spatial regions in the chamber, when compared to other regions in the chamber. These regions can have a higher temperature, as indicated in the heating pattern 425, when compared to the temperature of the other regions.

The controller can receive feedback, e.g., measurements obtained by one or more sensors in the chamber. The controller can process these measurements to determine a modified cooking process 420. For example, the controller can determine that some regions of the food product are colder than the other regions. The controller can accordingly modify the RF power output 415 of some, or all, of the antennas in the antenna assembly. The modified cooking process 420 can include a different pattern of heat distribution 425 inside the chamber, e.g., such that the colder regions in the initial cooking process 410 receive more RF power than the hotter regions. In this manner, the cooking device can modify the cooking process in order to improve uniformity and consistency of energy delivery to the food product in real-time as it is being cooked.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. An adaptive cooking device, comprising:
a cooking chamber configured to receive a food product;
an antenna assembly comprising a plurality of antennas, each antenna of the plurality of antennas coupled to an RF (Radio Frequency) power source and configured to deliver an RF power to the food product;
a sensor assembly coupled to the cooking chamber and comprising a plurality of sensors, each sensor configured to obtain a measurement characterizing a cooking process in real-time, and one or more sensors of the plurality of sensors configured to obtain a different type of the measurement; and
a controller coupled to the antenna assembly, the sensor assembly, and the RF power source, wherein the controller is configured to:
i) receive the measurement characterizing the cooking process from each of the sensors;
ii) process the measurement to determine a modified cooking process; and
iii) operate the antenna assembly and the RF power source in accordance with the modified cooking process in real-time.

2. The adaptive cooking device of claim 1, wherein the controller is configured to periodically receive the measurement characterizing the cooking process from each of the sensors.

3. The adaptive cooking device of claim 1, wherein the controller is further configured to activate or deactivate one or more sensors of the plurality of sensors in response to determining the modified cooking process.

4. The adaptive cooking device of claim 1, wherein the controller is configured to process the measurement to determine the modified cooking process using a trained machine learning model.

5. The adaptive cooking device of claim 4, wherein the machine learning model has been trained using supervised learning techniques.

6. The adaptive cooking device of claim 4, wherein the trained machine learning model is configured to determine correlations between the measurements.

7. The adaptive cooking device of claim 1, wherein the plurality of sensors include one or more of: a visible imaging camera, and infrared imaging camera, a spectral imaging camera, a mass sensor, a humidity sensor, a sound sensor, a motion sensor, an RF sensor, a rheology sensor, a thermocouple, a sound transducer, a gas sensor, a conductivity sensor, a light sensor, a pulse oximeter, an air pressure sensor and an ozone sensor.

8. The adaptive cooking device of claim 1, wherein the controller is further configured to:
i) receive external data characterizing the food product; and
ii) process the measurement and the external data characterizing the food product to determine the modified cooking process.

9. The adaptive cooking device of claim 1, wherein the controller is configured to operate the antenna assembly in accordance with the modified cooking process by adjusting one or more of: a frequency, a phase, and the RF power, of each of the plurality of antennas in real-time.

10. The adaptive cooking device of claim 1, wherein the measurement characterizing the cooking process in real time comprises one or both of a state of the cooking chamber and a state of the food product.

11. The adaptive cooking device of claim 1, further comprising a movable deflector configured to support the food product, and
wherein the controller is coupled to the movable deflector and configured to operate the antenna assembly and the movable deflector in accordance with the modified cooking process in real-time.

12. A method for preparing a food product using an adaptive cooking device that includes: (i) a cooking chamber, (ii) an antenna assembly comprising a plurality of antennas, (iii) a sensor assembly comprising a plurality of sensors, wherein one or more sensors of the plurality of sensors are configured to obtain a different type of a measurement that characterizes a cooking process, (iv) an RF power source, and (v) a controller, the method comprising:
operating, by the controller, the antenna assembly and the RF power source, to deliver an RF power to the food product disposed in the cooking chamber according to an initial cooking process;
obtaining, in real-time and by the plurality of sensors, the measurement that characterizes the initial cooking process;
receiving, by the controller, the measurement that characterizes the initial cooking process;
processing, by the controller, the measurement to determine a modified cooking process; and
operating, by the controller, the antenna assembly and the RF power source according to the modified cooking process.

13. The method of claim 12, further comprising:
receiving, by the controller, external data characterizing the food product; and
determining, by the controller, the initial cooking process based on the external data.

14. One or more non-transitory computer-readable storage medium coupled to one or more processors that, when executed by the one or more processors, cause the one or more processors to perform operations for preparing a food product using an adaptive cooking device that includes: (i) a cooking chamber, (ii) an antenna assembly comprising a plurality of antennas, (iii) a sensor assembly comprising a plurality of sensors, wherein one or more sensors of the plurality of sensors are configured to obtain a different type of a measurement that characterizes a cooking process, (iv) an RF power source, and (v) a controller, the operations comprising:
operating, by the controller, the antenna assembly and the RF power source, to deliver an RF power to the food product disposed in the cooking chamber according to an initial cooking process;
obtaining, in real-time and by the plurality of sensors, the measurement that characterizes the cooking process;
receiving, by the controller, the measurement that characterizes the cooking process;
processing, by the controller, the measurement to determine a modified cooking process; and
operating, by the controller, the antenna assembly and the RF power source according to the modified cooking process.
